(19) United States
(12) Patent Application Publication
(10) Pub. No.: US 2025/0073946 A1
(43) Pub. Date: Mar. 6, 2025

(54) Cutting device and cutting method using a running heating wire

(71) Applicant: UNIVERSITÉ DE TECHNOLOGIE DE TROYES, TROYES (FR)

(72) Inventor: Laurent DANIEL, MARAYE EN OTHE (FR)

(21) Appl. No.: 18/698,227

(22) PCT Filed: Oct. 3, 2022
(86) PCT No.: PCT/EP2022/077468

§ 371 Date: Nov. 12, 2024

(30) Foreign Application Priority Data
Oct. 4, 2021 (FR) 2110466

(51) Int. Cl. B26F 3/12

(52) U.S. Cl. CPC B26F 3/12

(57) ABSTRACT

The invention proposes a cutting device for cutting a material, comprising a cutting wire (3) having two ends, each end being connected to a winding drum (1a, 1b), the wire (3) being tensioned, the wire (3) being conductive and having a voltage applied to it in order to heat. This cutting device is characterized in that the wire (3) is unwinding at the moment of cutting, with winding around a first drum (1a) taking place simultaneously to unwinding from a second drum (1b), the device having a dry cutting zone (2) in which is located an unwinding section of wire (3) able to cut the material coming into contact with it, the two drums (1a, 1b) being driven in rotation by two different motors (4).

### TECHNICAL FIELD OF THE INVENTION

The invention relates to a cutting device for cutting a material.

This device comprises a cutting wire.

The materials suitable for cutting can be of various kinds, in particular organic materials, plastics, minerals, ice, glass or certain metals, etc.

Preferably, this device is designed for cutting wood.

It allows a three-dimensional cutting.

The invention also relates to a method for cutting a material using such a cutting device.

### TECHNICAL BACKGROUND

There are solutions for cutting with a static, tensioned heated wire. These solutions have a low effective cutting power, and have been used for decades to cut expanded or extruded polystyrene or various plastic foams.

To achieve a good metal-cutting efficiency, cutting solutions using conventional electro-erosion systems are used.

The electro-erosion consists of removing material from a conductive part, eroding it to give it the desired shape and dimensions using electrical discharges. In the scope of wire electro-erosion, an under tension running metal wire is immersed in water or another insulating liquid (dielectric) with the part to be worked. The current sent through forms an electric arc that causes a precise, programmed damage to a portion of the part. The residues created by wear on the part are evacuated by the water or the dielectric liquid.

The electro-erosion has a number of disadvantages. Firstly, only the conductive materials can be cut. Secondly, the material removal is slow, while the power consumption is high. In addition, there is a rapid erosion of the wire.

Water jet cutting solutions are also well known. However, when the cut material is wet, it is not possible to follow this up with a gluing step on a production line, as a wet material cannot be glued.

### SUMMARY OF THE INVENTION

The purpose of the present invention is to overcome the various disadvantages set out above, by means of a cutting device which allows to cut various types of material, whether conductive or not, using a wire, quickly and cleanly, with a low power consumption, and while offering a good cutting capacity.

The cutting device for cutting a material according to the invention comprises, in a conventional manner, a cutting wire having two ends, each end being connected to a winding drum, said wire being tensioned, said wire being conductive and placed under electrical power in order to heat.

The main characteristic of this cutting device is that said wire is running at the time of the cutting, with a winding around a first drum simultaneously with an unwinding from a second drum, said device having a dry cutting area in which there is a section of running wire capable of cutting the material coming into contact with it, the two drums being driven in rotation by two different motors.

There is no immersion. There is no water or insulating liquid. The cut is dry.

The cutting is preferably carried out in the open air, without any specific temperature, humidity or other conditions.

The main idea behind this invention is to cut material by means of a heating and running wire.

The wire is no longer static, as it was in some prior art.

And it is the wire itself that cuts into the material when it comes into contact with it. So it's no longer a question of cutting with an electric arc that degrades the material, as in the prior art. In the case of the present invention, the wire slices the material by thermal effect, either by melting it or by pyrolysis.

This technique saves energy, as there is no arc to supply.

The cutting according to the invention is easy to implement, requires a little cutting effort, is silent and does not generate dust.

The wire is initially wound around a first drum, then unwinding when the device is switched on, and simultaneously winding around a second drum.

During this time, the wire cuts one or more parts at the level of a defined cutting area in the device.

To cut the part along a certain path depending on the cutting depth, on the cutting length and on the desired final shape, there is a relative movement between the part to be cut and the device. Either the device is movable while the part to be cut is stationary, or the part is movable while the device is stationary.

This cutting device allows to cut parts of any thickness.

This device offers a cutting precision to the order of 0.1 mm. This accuracy may vary slightly depending on the wire thickness chosen.

When the wire is running and heats up during cutting, there is a very high degree of wire creep. It is therefore necessary to compensate for this creep phenomenon by using mechanical means allowing to tension the wire in all circumstances.

In this case, both motors fulfil this function. More specifically, the motors allow the drums to rotate independently of each other. This means that when the wire creep, and therefore lengthens, it is possible to turn one drum faster than the other to compensate for this creep phenomenon and wind up more wire.

According to the various embodiments of the invention, which may be taken together or separately:
the cutting device comprises means for applying electrical power to the wire between two parts connected to two different potentials, by contact with the two parts: this allows to apply voltage to the wire in a precise area between these two parts, while allowing it to run. When the wire heats up, it is able to cut materials more easily. The amount of heat to apply to the wire depends on the material to be cut.
the two parts are located on either side of the cutting area. As the wire heats up more and more from one part to the next, it reaches its maximum temperature at the end of the cutting area.
the two parts are located upstream of the cutting area. As the wire heats up more and more from one part to the next, it reaches its maximum temperature at the start of the cutting area, then gradually cools down.
the two parts with different potentials are pulleys over which the wire circulates.
the two parts with different potentials are brushes on which the wire rubs.
the temperature of the wire under electrical power is between 0° C. and 1000° C. This temperature will be chosen in particular according to the ultimate mechanical strength at high temperature of the material used for the wire.
each brush has a contact face on which the wire rubs as it is running: the voltage is therefore defined between these two brushes.
each brush is rotatable about an axis of rotation, the contact faces being orthogonal to the respective axes of rotation X: this has the effect of distributing the wear over the entire surface of each contact face, and avoiding the formation of a wear groove on the contact face.
the cutting device comprises means for dissipating the heat accumulated by the wire and the elements of the device in contact with the hot wire,
this is because the wire is heated at the level of the cutting area, and arrives hot on the pulleys and the carbon brushes downstream of the cutting area, which therefore tend to overheat. So they need to be cooled to prevent them from spoiling.
said heat dissipation means consist of fans cooling said elements as they leave the cutting area.
said heat dissipation means consist of a jet of compressed air.
the direction of unwinding of the wire is reversible: it is possible to change the direction of unwinding of the wire at any time by reversing the direction of rotation of the motors.
the cutting device comprises a frame on which the winding drums are attached, the wire travelling from one drum to the other along the frame.

The invention also relates to a method for cutting a material with a cutting device as described above. This method comprises the following steps:
rotating the drums to run the wire into a cutting area;
electrically powering the wire in the vicinity of the cutting area;
bringing the material into contact with the wire at the level of the cutting area, along an orientation and a cutting path.

Preferably, the wire running speed is adjustable. This speed is therefore variable.

Preferably, the electrical voltage applied to the wire is adjustable. This voltage is therefore variable. This gives a wire temperature range of between 0° C. and 1000° C. This also allows the wire temperature to be set and controlled.

### BRIEF DESCRIPTION OF THE FIGURES

Further characteristics and advantages of the invention will become apparent from the following detailed description, for the understanding of which reference is made to the appended drawings in which:

FIG. 1 is a general perspective view of the cutting device according to the invention;

FIG. 2 is a perspective view of the cutting area of the cutting device in FIG. 1;

FIG. 3 is a simplified schematic view of a first configuration of the cutting device as shown in FIGS. 1 and 2;

FIG. 4 is a simplified schematic view of a second configuration of the cutting device;

FIG. 5 is a simplified schematic view of a third configuration of the cutting device.

### DETAILED DESCRIPTION OF THE INVENTION

In the remainder of the description, elements having an identical structure or similar functions will be designated by the same references.

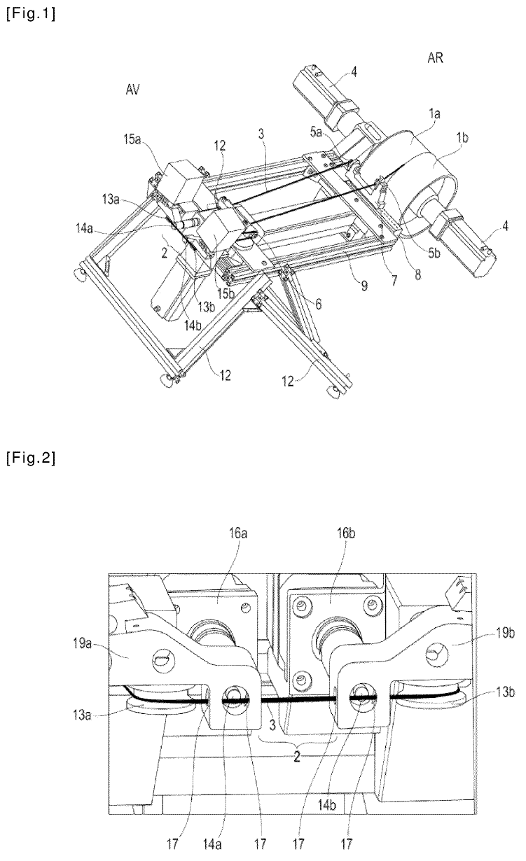

FIG. 1 illustrates a first possible configuration of a cutting device according to the invention.

The cutting device comprises a frame 9 on which the various main elements of the cutting device are mounted. Given its large external dimensions, the cutting device is stationary, and the part to be cut will move relative to the cutting device.

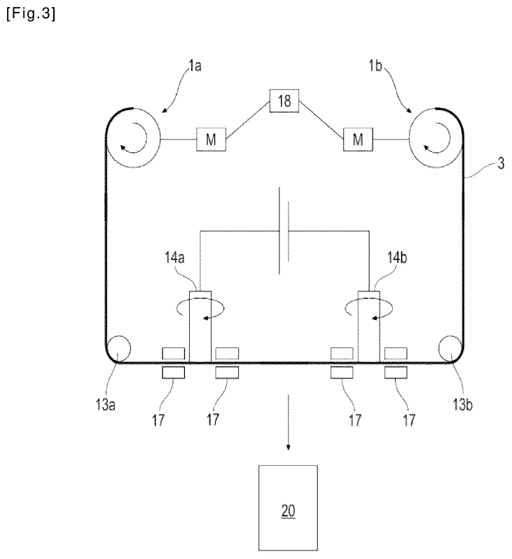

It would be entirely conceivable to provide a smaller, simplified cutting device, as in FIG. 3 for example, which would therefore be much easier to handle and could be moved in relation to a stationary part to be cut 20. Both variants therefore fall within the scope of the present invention.

The cutting device as shown in FIG. 1 therefore has a frame 9 fitted with bases 12 so that it rests stably on the ground.

A cutting wire 3 runs through this frame 9 at various points, from a rear portion AR of the frame 9 where there are two wire winding drums 1a, 1b, towards a front portion AV where there is a cutting area 2.

It should be noted that this frame 9 could be arranged differently, for example by extending in width rather than in depth, with a first drum in the front portion on the right-hand side of the cutting area 2 and a second drum in the front portion on the left-hand side of the cutting area 2. It is therefore possible to envisage several orientations and several types of frame 9 arrangement within the scope of the present invention.

The wire 3 has a predefined length. For example, it can be 400 metres long.

It has a first end attached to a first drum 1a, and a second end attached to a second drum 1b. Between the two drums 1a, 1b. the wire 3 follows a certain path along the frame 9.

The wire 3 has a substantial winding length. It is wound around one of the two drums 1a, 1b when it is first installed.

Each drum 1a, 1b is driven in rotation by a motor 4.

The wire 3 is attached to the drums 1a, 1b so that, as the wire 3 unwinds from the first drum 1a, it simultaneously winds around the second drum 1b. And conversely, when the wire 3 is wound around the first drum 1a, it is simultaneously unwound from the second drum 1b.

The two drums 1a, 1b are driven in rotation by two different motors 4.

In FIG. 1, the two drums 1a, 1b are located side by side. It should be noted that the two drums 1a, 1b must be separated and insulated from each other, for example by an insulating spacer, as each drum 1a, 1b is at a different electrical potential.

In FIG. 3, for example, the drums 1a, 1b are spaced apart and driven by two different motors.

When the cutting device starts to operate, a first drum 1a is driven in rotation so as to unwind the wire 3, and the wire 3 then travels the entire length of the frame 9 until it reaches the cutting area 2 at the front AV, then again travels the entire length of the frame 9 to return to the rear portion AR to be wound in the opposite direction around the second drum 1b. This configuration is illustrated, for example, in FIG. 1.

In the configuration shown in FIG. 3, the drums 1a, 1b are also driven in the same direction, and the wire 3 is wound in the opposite direction around each of the drums 1a, 1b.

Once the first drum 1a has been completely unwound, the motors 4 simply need to be operated in the opposite direction so that the wire 3 unwinds from the second drum 1b and is then wound around the first drum 1a.

It would also be possible to provide two drums driven in rotation in opposite directions, with a wire wound in the same direction around each drum. The result would be identical. All these configurations fall within the scope of the present invention.

The wire 3 is permanently tensioned. The wire 3 needs to be tensioned, particularly in the cutting area 2, so that a clean cut can be made in the material to be cut. To achieve this, the motors 4 are servo-controlled by a control device 18 so as to rotate the drums 1a, 1b to a greater or lesser extent in order to maintain a constant tension in the wire 3.

Before reaching the cutting area 2, the wire 3 passes over various pulleys 6, 12, 13, which allow the wire 3 to be correctly oriented until it reaches the cutting area 2. The arrangement of these different pulleys is symmetrical on either side of the cutting area 2, since the direction of running of the wire 3 is reversible.

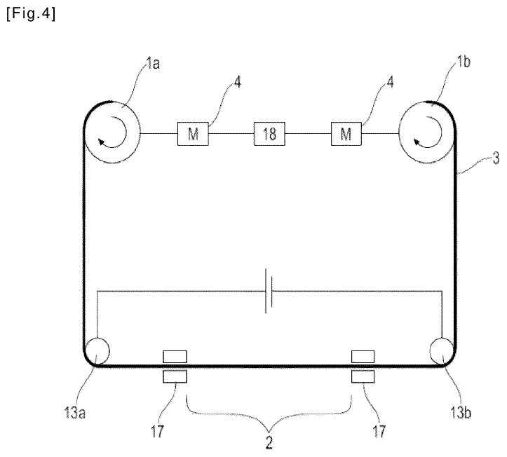

The cutting area 2 will now be described in accordance with FIGS. 2 and 4.

In this cutting area 2, the wire 3 is placed under electrical power by rubbing against two brushes 14a, 14b, each brush 14a, 14b being connected to a different electrical potential. For example, the first potential is 0 V, and the other potential is 24 V. A voltage of 24 V is therefore applied to the wire 3 between these two brushes 14a, 14b. These two brushes 14a, 14b thus correspond to two electrical terminals.

In this example, the brushes 14a, 14b are arranged on either side of the cutting area 2. So the wire starts to heat up when the first brush passes, and stops heating up when the second brush passes. The wire thus reaches its maximum temperature as it passes the second brush, i.e. as it leaves the cutting area.

However, these brushes could be positioned just upstream of the cutting area 2. The wire therefore heats up between the two upstream brushes, reaching its maximum temperature as it passes the second brush, i.e. at the entrance to the cutting area.

The key is to ensure that the wire 3 is hot when cutting.

The brushes 14a, 14b, also referred to as “carbon brushes”, are preferably made from graphite or carbon, or any other conductive material capable of withstanding friction at high temperatures.

The brushes 14a, 14b are cylindrical in shape and have a central axis corresponding to their direction of extension.

Each brush 14a, 14b has a contact face with the wire 3 oriented perpendicular to their central axis.

The wire 3 thus rubs against this contact face of each brush 14a, 14b.

This double friction allows the electrical voltage to be transmitted to the wire 3 between these two brushes 14a, 14b. The wire 3 heats up in this cutting area by Joule effect.

By varying the electrical voltage applied to the wire 3, the amount of energy supplied to the wire 3 can be varied, thereby varying the temperature of the wire 3.

By adjusting the running speed of the wire 3, the amount of energy transmitted to the material to be cut can also be varied.

The cutting area 2 is therefore delimited between these two brushes 14a, 14b, and the section of wire 3 running between these two brushes 14a, 14b is used for cutting by being brought into contact with the material to be cut. The fact that the wire 3 is tensioned, heated and running makes it easy to cut the material.

Advantageously, the brushes 14a, 14b are rotatable about their central axis. Each brush 14a, 14b has a motor 16a, 16b to turn it.

Thanks to this rotation, the wire 3 rubs on the contact face over the entire surface of the contact face, and not just in one area, in order to avoid creating a wear crevice on the contact face.

The brushes 14a, 14b can be moved in translation along their central axis to compensate for wear on the contact face and to ensure the contact between the wire 3 and the contact face. For example, this axial movement can be ensured by a spring located at the base of each brush 14a, 14b.

Guide beads 17 are provided on either side of the cutting area 2 to guide the wire 3 as best as possible through the cutting area 2. These beads 17 are preferably made of ceramic in order to be electrically insulating and heat resistant.

These beads 17 are provided in support parts 19a, 19b connected to the frame 9.

The width of the cutting area 2 is adjustable, in particular according to the size of the parts to be cut.

On either side of the cutting area 2, adjacent to each brush 14a, 14b, is a pulley 13a, 13b allowing the orientation of the wire 3 to be changed from the rear AR of the frame 9 towards the cutting area 2.

In the case illustrated, these pulleys 13a, 13b are designed with a ceramic rolling bearing providing a galvanic insulation, so that each pulley is electrically insulated.

Another configuration is illustrated in FIG. 4, which repeats the description below, except for the brushes. In this case, there are no rotating brushes.

The pulleys 13a, 13b are made of a conductive material and are connected to a different electrical potential. For example, the first potential is 0 V, and the other potential is 24 V. A voltage of 24 V is therefore applied to the wire 3 between these two pulleys 13a, 13b. These two pulleys 13a, 13b thus correspond to two electrical terminals. The pulleys 13a, 13b are arranged on either side of the cutting area 2. In this way, the wire starts to heat up as it passes over the first pulley, and stops heating up as it passes over the second pulley. The wire 3 thus reaches its maximum temperature as it passes over the second pulley, i.e. as it leaves the cutting area.

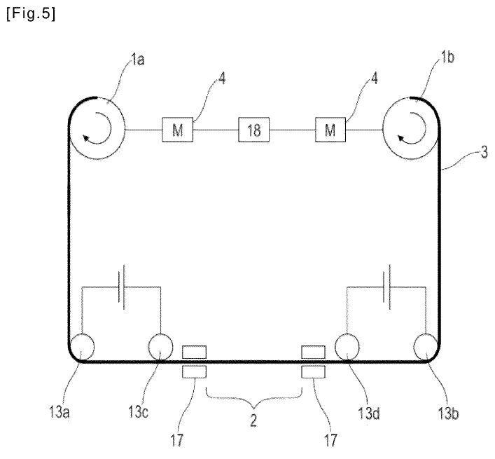

However, in another configuration illustrated in FIG. 5, the pulleys that send an electric current to the wire 3 could be arranged just upstream of the cutting area 2, instead of being arranged on either side of the cutting area 2.

The wire 3 thus heats up between the two pulleys 13b and 13d upstream of the cutting area 2 as the wire 3 runs from right to left in the diagram, and reaches its maximum temperature as it passes the second pulley 13d, i.e. at the entrance to the cutting area 2. The pulleys 13c and 13a downstream of the cutting area 2 are not powered.

And conversely, the wire 3 heats up between the two pulleys 13a and 13c upstream of the cutting area 2 as the wire 3 runs from left to right in the diagram, and reaches its maximum temperature as it passes the second pulley 13c, i.e. at the entrance to the cutting area 2. The pulleys 13d and 13b downstream of cutting area 2 are not supplied with power.

The key is to ensure that the wire 3 is hot when cutting.

Whatever configuration is chosen, all the elements located in the cutting area 2 and more generally in the vicinity of the cutting area 2 tend to overheat as a result of the hot wire 3 passing over them. In fact, the wire transmits its calories to the elements with which it comes into contact. They are pulleys 13, beads 17 or brushes 14.

To prevent damage to these various elements, the cutting device comprises means for dissipating the heat accumulated by these elements. Preferably, these heat dissipation means consist of fans 15a, 15b which allow fresh air to be supplied to these elements. In this case, there is a fan 15a, 15b on either side of the cutting area 2. These fans 15a, 15b are illustrated by the two blocks in FIG. 1.

These heat dissipation means can also consist of a compressed air system.

Any other heat dissipation system is conceivable within the scope of the present invention.

Between the pulleys 13a, 13b and the drums 1a, 1b, the wire 3 passes over other pulleys, which allow the orientation of the wire 3 to be changed as required, so that it is perfectly positioned at the level of the cutting area 2.

The wire 3 is mechanically tensioned by the two motors 4. Having a separate motor 4 for each drum 1a, 1b means that the drums 1a, 1b can be rotated independently of each other, and at different speeds, in particular to be able to wind more length of wire 3 after a phenomenon of wire 3 creep which occurs as a result of heating the wire 3. These motors 4 thus allow to compensate for the elongation of the wire 3. The motors 4 are controlled so as to maintain tension on the wire 3.

When the wire 3 breaks, a control system detects the absence of voltage, for example a torque measurement at ONm, and stops the motors 4.

During the cutting phase, a vibration phenomenon occurs. The wire starts to vibrate, which can cause variations in the torque measurement. To avoid this phenomenon and stop the vibrations, anti-vibration systems (not shown) located on either side of the cutting area 2 and connected to the frame 9 can be used to come into contact with the wire 3 and stop the vibrations.

Preferably, wire guide pulleys 5a, 5b are attached to at least one carriage 7 sliding on a strip 8 attached to the frame in the vicinity of the drums 1a, 1b. This allows the pulleys 5a, 5b to be moved along the drums 1a, 1b as they are wound and unwound, so that the wire 3 is wound/unwound cleanly across the entire width of the drums 1a, 1b. Each carriage 7 moves perpendicular to the direction of the wire 3, and parallel to the axis of rotation of the drums 1a, 1b.

Several parameters can be set in this cutting device, including:
the speed at which the wire 3 runs, by adjusting the speed of rotation of the motor or motors 4 of the drums 1a, 1b;
the distance of the cutting area 2;
the electrical voltage: the higher the voltage, the more the wire 3 heats up through the Joule effect;
the material used for the wire 3;
the diameter of the wire 3.

The speed of approach to the material to be cut can also be varied, depending in particular on the thickness of the material. In fact, it is necessary to slow down the advance of the material in thick areas, for example during 3D cutting, if the material is tilted in relation to the wire 3.

The temperature range of the wire 3 also depends on the material to be cut.

The temperature of the wire 3 must remain above the melting temperature of the material to be cut, in the case of fusion cutting, or above the pyrolysis temperature, in the case of pyrolysis cutting.

For example, to cut the ice, it is not necessarily necessary to heat the wire.

To cut wood, however, the wire 3 has to be heated above the pyrolysis temperature of the wood, which is around 300° C.

To cut a metallic material, such as aluminium, we use a stainless steel wire 3 heated above the melting temperature of aluminium, i.e. around 600° C.

For cutting mineral materials, a tungsten wire 3 is preferred. The cutting should be carried out in a neutral or non-oxidising atmosphere, as tungsten oxidises above 800° C.

In general, the stainless steel wire 3 is preferred.

The wire 3 is a low-cost consumable that can be reused a number of times.

The wire 3 can be relatively long, for example of the order of 1.5 km, so that it has time to cool on the drum once it has passed the cutting area 2, and before the direction of the wire 3 is reversed when the first drum 1a is completely unwound. Having a very long wire also means that the wire can be used for longer before it breaks.

The configurations shown in the cited figures are only possible examples, in no way limiting, of the invention which, on the contrary, encompasses the variations of shapes and designs within the reach of the person skilled in the art.

1. A cutting device for cutting a material, comprising a cutting wire having two ends, each end being connected to a winding drum, said wire-being tensioned, said wire being conductive and placed under electrical power in order to heat, wherein said wire is running at the time of cutting, with a winding around a first drum simultaneously with an unwinding from a second drum, said device having a dry cutting area in which there is a section of running wire capable of cutting the material coming into contact with it, the two drums being driven in rotation by two different motors.

2. The cutting device according to claim 1, further comprising means for electrically powering the wire between two parts connected to two different potentials, by contact with the two parts.

3. The cutting device according to claim 2, wherein the two parts are located on either side of the cutting area.

4. The cutting device as claimed in claim 2, wherein the two parts are located upstream of the cutting area.

5. The cutting device according to claim 2, wherein the two parts having different potentials are pulleys over which the wire circulates.

6. The cutting device according to claim 2, wherein the two parts having different potentials are brushes on which the wire rubs.

7. The cutting device according to claim 6, wherein each brush has a contact face on which the wire rubs as it is running.

8. The cutting device as claimed in claim 1, wherein each brush is rotatable about an axis of rotation, the contact faces being orthogonal to the respective axes of rotation X.

9. The cutting device according to claim 1, further comprising means for heat dissipation of the heat accumulated by the wire and the elements of the device in contact with the hot wire.

10. The cutting device according to claim 9, wherein said heat dissipation means consist of fans cooling said elements as they leave the cutting area.

11. The cutting device according to claim 1, wherein the unwinding direction of the wire is reversible.

12. The cutting device according to claim 1, further comprising a frame to which the winding drums are attached, the wire travelling from one drum to the other along the frame.

13. A method for cutting a material with a cutting device according to claim 1, said method comprising the following steps:
rotating the drums to unwind the wire into a cutting area;
electrically powering the wire in the vicinity of the cutting area;
bringing the material into contact with the wire at the level of the cutting area in a predefined orientation and cutting path.

14. The method according to claim 13, wherein the running speed of the wire is adjustable.

15. The method according to claim 13, wherein the electrical voltage applied to the wire is adjustable.
